(19) United States
(12) Patent Application Publication
(10) Pub. No.: US 2015/0071043 A1
(43) Pub. Date: Mar. 12, 2015

(54) Relative Clock Time Display Device and Relative Clock Time Display Program

(71) Applicant: convex corporation, ltd., Tokyo (JP)

(72) Inventor: Haruo Kubota, Tokyo (JP)

(73) Assignee: convex corporation, ltd., Tokyo (JP)

(21) Appl. No.: 14/399,304

(22) PCT Filed: Apr. 11, 2013
(86) PCT No.: PCT/JP2013/060891

§ 371 Date: Nov. 6, 2014

(30) Foreign Application Priority Data
May 7, 2012 (JP) 2012-105842

(51) Int. Cl. G04G 9/00; G04G 99/00

(52) U.S. Cl. CPC G04G 9/00; G04G 99/00
USPC 368/82

(57) ABSTRACT

A relative clock time display device includes a control unit that accepts setting of time that is referred to as a relative time, which is different from an actual time and in a relative relationship with the actual time, performs timing on a basis of the relative time accepted by the control unit, specifies a current clock time, which is referred to as a relative clock time, in the relative time on a basis of the timing performed by the control unit, and displays, on a display unit, an image or video according to the relative clock time specified by the control unit.

### CROSS REFERENCE TO RELATED APPLICATIONS

This application is a U.S. National Phase application under 35 U.S.C. §371 of International Patent Application No. PCT/JP2013/060891 filed Apr. 11, 2013, which claims priority to Japanese Patent Application No. 2012-105842 filed May 7, 2012. The International application was published on Nov. 14, 2013, as International Publication No. WO 2013/168511 under PCT Article 21(2). The entire contents of these applications are hereby incorporated by reference.

### TECHNICAL FIELD

The present invention relates to a relative clock time display device and a relative clock time display program.

### BACKGROUND

The following clock time control system for daylight saving time is known. This clock time control system for daylight saving time is adapted to adjust clock time setting of an internal clock in an elevator to daylight saving time during the daylight saving time. See, for example, Japanese Patent Application Publication No. JP 2010-111484 A.

However, the conventional clock time control system for daylight saving time has only been able to adjust the clock time setting of the internal clock in the elevator to the daylight saving time, and has been unable to set time at will to suit the perception of time of a user. Moreover, the system is not intended for time setting that suits the perception of time of the user, whereby there has not been any consideration of displaying a screen in accordance with the time setting performed by the user.

### SUMMARY

A relative clock time display device according to the present invention includes: relative time setting acceptance means which accepts setting of time (hereinafter referred to as a “relative time”) that is different from an actual time and in a relative relationship with the actual time; relative time timing means which performs timing on the basis of the relative time accepted by the relative time setting acceptance means; relative clock time specifying means which specifies a current clock time (hereinafter referred to as a “relative clock time”) in the relative time on the basis of the timing performed by the relative time timing means; and display control means which displays, on a display unit, an image or video according to the relative clock time specified by the relative clock time specifying means.

The relative clock time display device further includes clock image display means which displays on the display unit a clock image representing a clock, and the relative time setting acceptance means may be configured to accept setting of the relative time by accepting designation of correspondence between the actual time and the relative time on the clock image that is displayed by the clock image display means.

The display control means may be configured to change at least one of a color and brightness of the image displayed on the display unit according to the relative clock time.

The display control means may also be configured to display an image or video of sky on the display unit and change at least one of a color and brightness of the sky according to the relative clock time.

The display control means may be configured to display the relative clock time on top of the image or video.

A relative clock time display program according to the present invention causes a computer to execute: a relative time setting acceptance step of accepting setting of time (hereinafter referred to as a “relative time”) that is different from an actual time and in a relative relationship with the actual time; a relative time timing step of performing timing on the basis of the relative time accepted in the relative time setting acceptance step; a relative clock time specifying step of specifying a current clock time (hereinafter referred to as a “relative clock time”) in the relative time on the basis of the timing performed in the relative time timing step; and a display control step of displaying, on a display unit, an image or video according to the relative clock time specified in the relative clock time specifying step.

The relative clock time display program further includes a clock image display step of displaying, on the display unit, a clock image representing a clock, and the relative time setting acceptance step may be adapted to accept setting of the relative time by accepting designation of correspondence between the actual time and the relative time on the clock image that is displayed in the clock image display step.

The display control step may be adapted to change at least one of a color and brightness of the image displayed on the display unit according to the relative clock time.

The display control step may also be adapted to display an image or video of sky on the display unit and change at least one of a color and brightness of the sky according to the relative clock time.

The display control step may be adapted to display the relative clock time on top of the image or video.

According to the present invention, a user can set the relative time at will to suit his own perception of time. Moreover, the image or video according to the relative clock time is displayed to be able to make the user aware of the relative time by using an image.

### BRIEF DESCRIPTION OF DRAWINGS

FIG. 1 is a block diagram illustrating a configuration of a relative clock time display device 100 according to an example.

FIG. 2 is a first diagram illustrating an example of a relative time setting clock.

FIG. 3 is a first diagram illustrating an example where a relative time is set by using the relative time setting clock.

FIG. 4 is a second diagram illustrating an example where a relative time is set by using the relative time setting clock.

FIG. 5 is a third diagram illustrating an example where a relative time is set by using the relative time setting clock.

FIG. 6 is a flowchart illustrating a flow of processes executed by the relative clock time display device 100.

FIG. 7 is a second diagram illustrating an example of the relative time setting clock.

FIG. 8 is a third diagram illustrating an example of the relative time setting clock.

FIG. 9 is a fourth diagram illustrating an example of the relative time setting clock.

### DETAILED DESCRIPTION

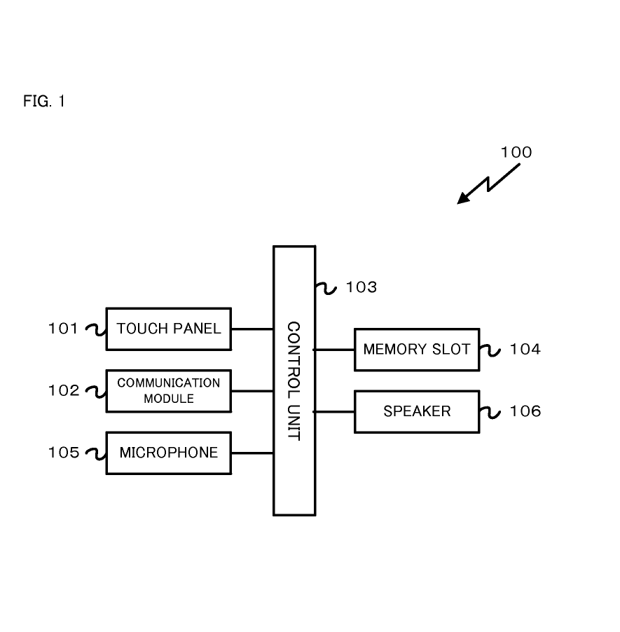

FIG. 1 is a block diagram illustrating a configuration of a relative clock time display device 100 according to an example. Various information terminals such as a personal computer, a smartphone, a mobile phone, a tablet, and a PDA are used as the relative clock time display device 100, which operates as the relative clock time display device 100 in the present example by installing a relative clock time display program to these information terminals. FIG. 1 illustrates the block diagram when the smartphone is used as the relative clock time display device 100.

The relative clock time display device 100 includes a touch panel 101, a communication module 102, a control unit 103, a memory slot 104, a microphone 105, and a speaker 106.

The touch panel 101 is an electronic component formed by combining a display unit such as a liquid crystal panel and a locator unit such as a touch pad, and is an input unit that can operate a device by pressing a display on a screen. A user of the relative clock time display device 100 can operate the relative clock time display device 100 by using a finger or a touch pen to touch or slide a display item such as a button and a menu displayed on the liquid crystal panel, for example. The touch panel 101 detects the touch or slide operation by the user and outputs a detected signal to the control unit 103.

A module used to connect to the Internet through an access point of a wireless LAN or a module used to connect to the Internet through a mobile phone communication network is used as the communication module 102. The relative clock time display device 100 uses the communication module 102 to be connected to the Internet, the mobile phone communication network, or the like and perform communication.

The control unit 103 includes a CPU, a memory, and another peripheral circuit and controls the entire relative clock time display device 100. Note that the memory included in the control unit 103 includes a volatile memory such as an SDRAM and a nonvolatile memory such as a flash memory. The volatile memory is used as a work memory in which a program is expanded when the CPU runs the program, and as a buffer memory in which data is temporarily recorded. Recorded in the nonvolatile memory includes program data of firmware used to operate the relative clock time display device 100 and software used to operate various applications. In the present example, for example, the relative clock time display program is provided as a relative clock time display application that is executable on the smartphone. The relative clock time display application is installed to the relative clock time display device 100 when the program data of the relative clock time display application obtained via download or the like is recorded in the nonvolatile memory.

The memory slot 104 is a slot into which an external memory such as a memory card is inserted. The user can increase the storage capacity of the relative clock time display device 100 by inserting the memory card into the memory slot 104. When the relative clock time display device 100 has a camera function, for example, image data acquired by photographing can be recorded in the memory card to be able to prevent the image data from pressing the capacity of the flash memory included in the control unit 103. It may also be adapted to be able to record relative clock time display program data in the memory card inserted into the memory slot 104.

The microphone 105 is a sound collecting unit used to input a speech sound by the user. The speaker 106 is an output unit used to output sound.

The relative clock time display device 100 in the present example includes a clock function which times the clock time. Specifically, a program used to realize the clock function is installed in the memory that is included in the control unit 103. An actual time, namely a Japan Standard Time when one is in Japan, is timed by the clock function.

The relative clock time display device 100 in the present example can further set a time that is different from the actual time and in a relative relationship with the actual time, thereby allowing the user to set a time of a day according to the perception of time he perceives. Specifically, the user can set at will a time (hereinafter referred to as a “relative time”) that suits his perception of time relative to 24 hours in the actual time.

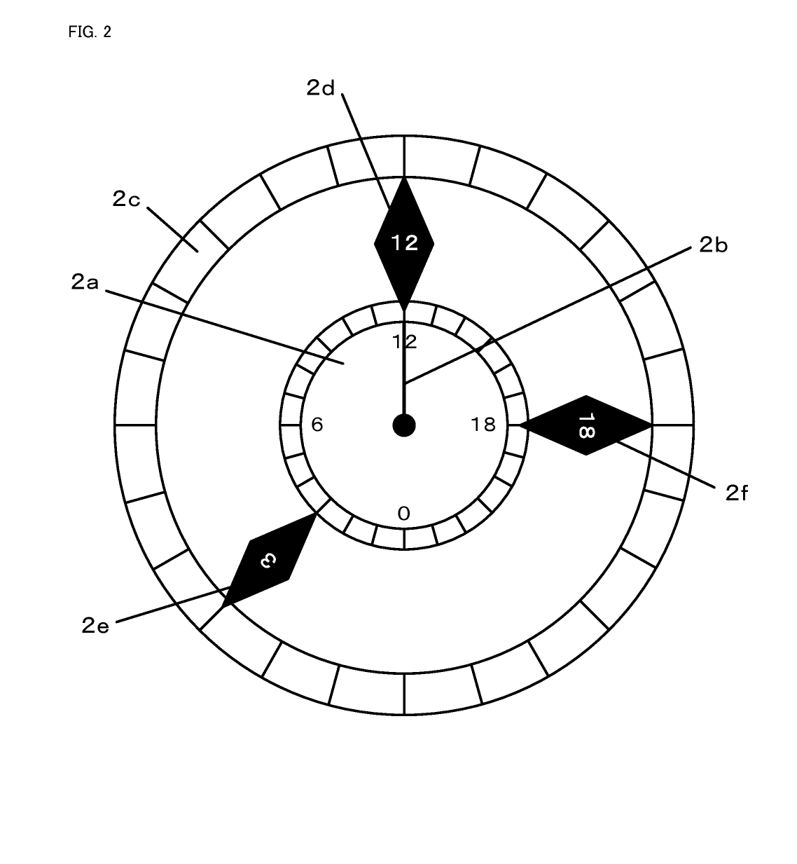

The user operates the touch panel 101 to display thereon an image representing a clock as illustrated in FIG. 2, for example. Here, the clock displayed as the image illustrated in FIG. 2 is referred to as a relative time setting clock. The user operates the relative time setting clock to be able to set at will the relative time that suits his perception of time relative to the 24 hours in the actual time. There will now be described a method of setting the relative time by using the relative time setting clock illustrated in FIG. 2.

As illustrated in FIG. 2, the relative time setting clock includes an actual time indicator panel 2a which represents the actual time in 24 hours a round, an actual clock time indicator hand 2b which represents a current clock time (hereinafter referred to as an “actual clock time”) in the actual time on the actual time indicator panel 2a, a relative time indicator panel 2c which represents the relative time in 24 hours a round, and relative time setting hands 2d to 2f used by the user to set the relative time. Here, the relative time setting hand 2d is a hand indicating 12 o'clock in the relative time, the relative time setting hand 2e is a hand indicating 3 o'clock in the relative time, and the relative time setting hand 2f is a hand indicating 18 o'clock in the relative time.

The user touches any of the relative time setting hands 2d to 2f on the touch panel 101 and slides the hand in a circumferential direction of the relative time indicator panel 2c to be able to move the relative time setting hands 2d to 2f in the circumferential direction on the relative time indicator panel 2c and change the time indicated by the relative time setting hands 2d to 2f.

The user can therefore set the relative time to the actual time displayed on the actual time indicator panel 2a. That is, the user can indicate the correspondence between the actual time represented by the actual time indicator panel 2a and the relative time represented by the relative time indicator panel 2c by using and moving the relative time setting hands 2d to 2f in the circumferential direction on the relative time indicator panel 2c. There will now be described an example of setting the relative time by using the relative time setting hands 2d to 2f.

The user whose perception of time corresponds with the actual time may arrange the relative time setting hand 2d to indicate 12 o'clock on the actual time indicator panel 2a, arrange the relative time setting hand 2e to indicate 3 o'clock on the actual time indicator panel 2a, and arrange the relative time setting hand 2f to indicate 18 o'clock on the actual time indicator panel 2a, as illustrated in FIG. 2.

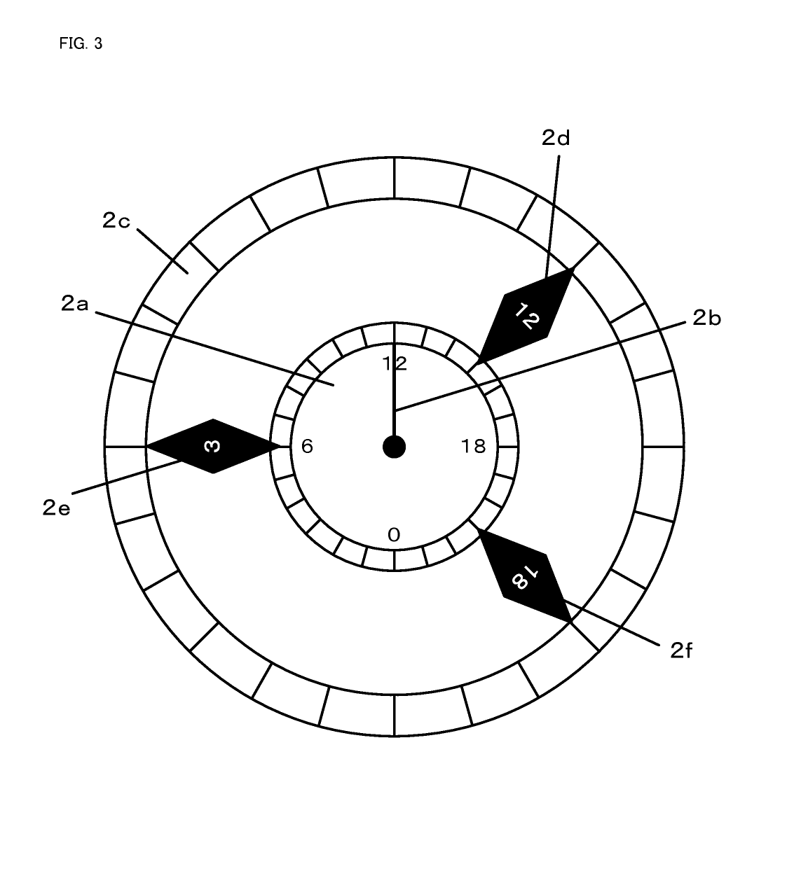

On the other hand, the user whose perception of time does not correspond with the actual time can set the relative time as follows to suit his perception of time. Here, there will be described an example where the relative time is set by the user whose perception of time is three hours ahead of the actual time. This user perceives 12 o'clock in the actual time as 15 o'clock in the relative time, 18 o'clock in the actual time as 21 o'clock in the relative time, and 3 o'clock in the actual time as 6 o'clock in the relative time. Accordingly, as illustrated in FIG. 3, the user arranges the relative time setting hand 2d to indicate 15 o'clock on the actual time indicator panel 2a, arranges the relative time setting hand 2e to indicate 6 o'clock on the actual time indicator panel 2a, and arranges the relative time setting hand 2f to indicate 21 o'clock on the actual time indicator panel 2a. As a result, the user can set the relative time in accordance with his perception of time that is three hours ahead of the actual time. Note that when all the relative time setting hands are moved by the same number of hours as is the case here, the user can touch an arbitrary point on the relative time indicator panel 2c and slide the finger in the circumferential direction to move the relative time setting hands 2d to 2f all at once. This allows the user to change the time indicated by the relative time setting hands 2d to 2f altogether.

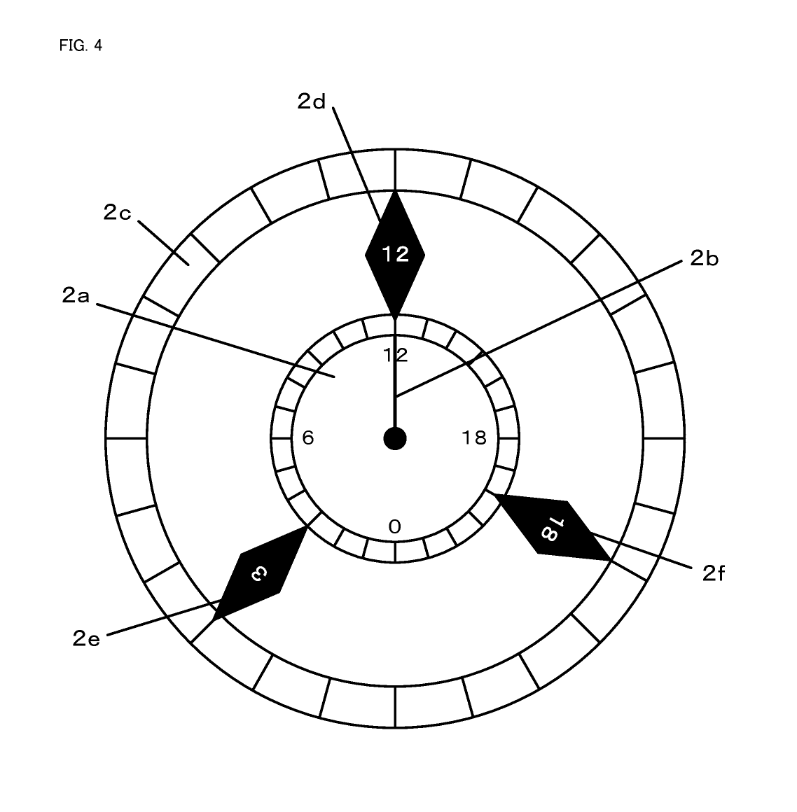

Moreover, the user whose perception of time makes him feel that daytime hours are longer than the actual time, for example, can set the relative time such that the corresponding hours are set longer than the actual time. There will be described an example where the relative time is set by the user whose perception of time makes him feel the duration of six hours between 12 o'clock and 18 o'clock in the actual time as eight hours. This user perceives 12 o'clock in the actual time as 12 o'clock in the relative time, 18 o'clock in the actual time as 20 o'clock in the relative time, and 3 o'clock in the actual time as 3 o'clock in the relative time. Accordingly, as illustrated in FIG. 4, the user arranges the relative time setting hand 2d to indicate 12 o'clock on the actual time indicator panel 2a, arranges the relative time setting hand 2e to indicate 3 o'clock on the actual time indicator panel 2a, and arranges the relative time setting hand 2f to indicate 20 o'clock on the actual time indicator panel 2a. As a result, the user can set the relative time in accordance with the perception of time that makes him feel the duration from 12 o'clock to 18 o'clock in the actual time as eight hours.

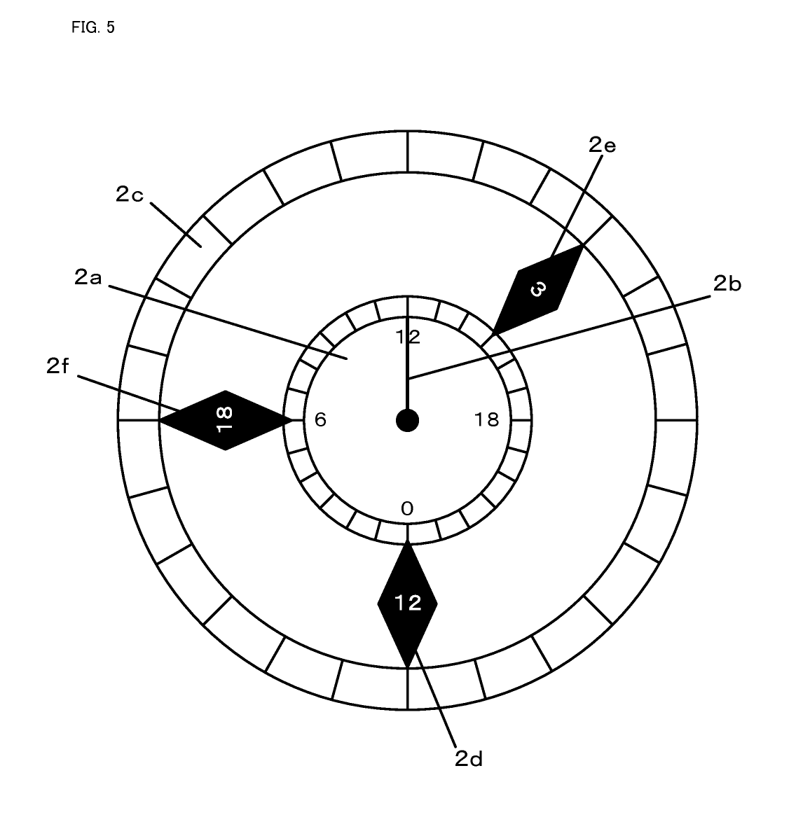

FIG. 5 illustrates an example where the relative time is set by the user who has the perception of time in which day and night are reversed. As illustrated in FIG. 5, the user arranges the relative time setting hand 2d to indicate 0 o'clock on the actual time indicator panel 2a, arranges the relative time setting hand 2e to indicate 15 o'clock on the actual time indicator panel 2a, and arranges the relative time setting hand 2f to indicate 6 o'clock on the actual time indicator panel 2a. As a result, the user can set the relative time in accordance with the perception of time in which the day and night are reversed. The control unit 103 specifies settings of the relative time set by the user on the relative time setting clock, and records in the flash memory a piece of relative time setting information which specifies the settings of the relative time.

According to the relative clock time display device 100 of the present example, the user can set the relative time in a day in accordance with his perception of time, as described above. The user can therefore use the relative clock time display device 100 of the present example for the following purposes, for example.

(1) Adjusting Biological Clock of User

When a biological clock of the user does not match the actual time due to an irregular lifestyle, the user first leads a life by setting the relative time in accordance with his own perception of time.

After that, the relative time is set closer to the actual time every fixed period so that, when the actual time eventually matches the relative time, the biological clock of the user can correspond with the actual time. The user can adjust his biological clock to correspond with the actual time after working a late shift or night shift, for example.

(2) Recovering from Jet Lag Caused by Travel Abroad

When traveling abroad where a local time is set as the actual time, the user sets the relative time in accordance with his perception of time that is disturbed due to a jet lag. After that, the relative time is set closer to the local actual time every fixed period so that, when the actual time eventually matches the relative time, the user can slowly recover from the jet lag.

(3) Adjusting Gap Between Personal Daily Rhythm of User and Actual Time

When the user feels a gap between his personal daily rhythm and the actual time, the user first leads a life by setting the relative time in accordance with his own personal daily rhythm. After that, the relative time is set closer to the actual time every fixed period so that, when the actual time eventually matches the relative time, the user can adjust the personal daily rhythm in accordance with the actual time.

(4) Play with Time to Spend a Day Happily

The user can set the relative time such that the hours in a day are allocated to make him feel that an enjoyable time lasts longer and an unexciting or boring time lasts shorter. The user may set the relative time longer compared to the actual time when he is with someone he likes, or set the relative time shorter compared to the actual time when he is having the unexciting or boring time, for example. This allows the user to play with time in order to spend a day happily by feeling the same four hours as six hours when he is with someone he likes, or as two hours when he is having the unexciting or boring time.

After the relative time is set by the user, the control unit 103 performs timing on the basis of the relative time being set, and displays on the touch panel 101 a current clock time (hereinafter referred to as a “relative clock time”) based on the relative time, on the basis of an instruction from the user to display the relative time.

In the present example, the control unit 103 notifies the user of the relative clock time by displaying an image of sky indicating the relative clock time on the touch panel 101. A clock representing the relative clock time by using the image of sky is referred to as a sky clock in the present example. Specifically, the control unit 103 displays an image indicating morning glow when the relative clock time corresponds to morning in the actual time, and displays an image indicating a clear sky when the relative clock time corresponds to daytime in the actual time. Moreover, the control unit 103 displays an image indicating sunset when the relative clock time corresponds to evening in the actual time, and displays an image indicating a starry sky when the relative clock time corresponds to nighttime in the actual time. The control unit 103 may be further adapted to display the relative clock time in numbers or characters on top of the image of sky.

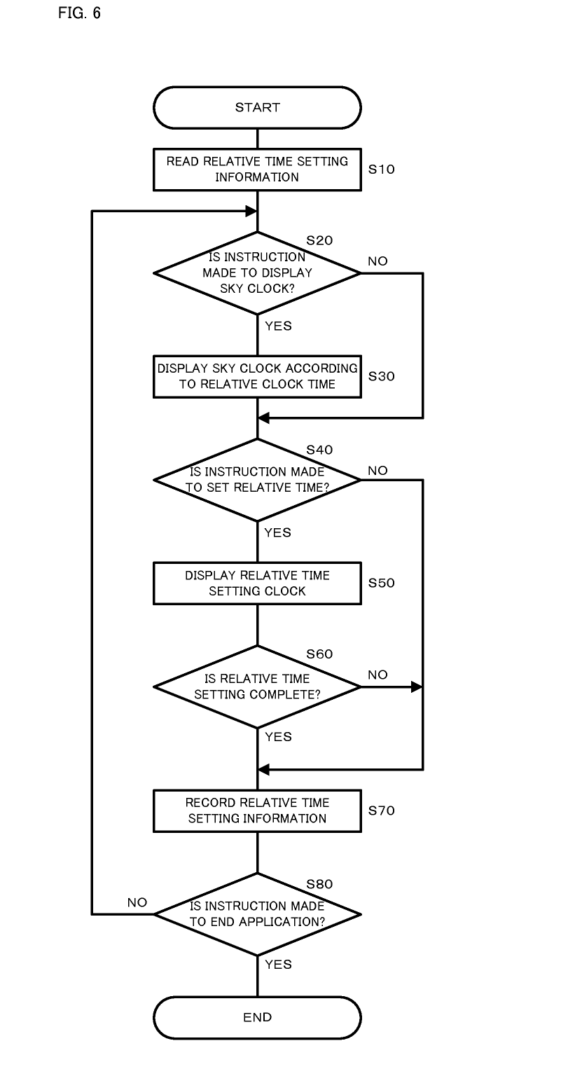

FIG. 6 is a flowchart illustrating a flow of processes executed by the relative clock time display device 100 according to the present example. The processes illustrated in FIG. 6 are executed by the control unit 103 as a program that is launched when a relative clock time display application is run by the user. Note that the user can launch the relative clock time display application by selecting and touching an icon of the relative clock time display application from among icons arranged on the touch panel 101.

In step S10, the control unit 103 reads relative time setting information from the flash memory. Note that the relative time setting information is not recorded in the flash memory when the relative clock time has not yet been set by the user, in which case the read is not performed. The process thereafter proceeds to step S20.

In step S20, the control unit 103 determines whether or not an instruction to display the sky clock is made by the user. The process proceeds to step S40 below when the determination in step S20 is negative. On the other hand, the process proceeds to step S30 when the determination in step S20 is affirmative.

In step S30, the control unit 103 specifies the settings of the relative time on the basis of the relative time setting information read in step S10. The control unit 103 then specifies a current relative clock time on the basis of the settings of the relative time specified, and displays the sky clock corresponding to the specified current relative clock time as described above. The process thereafter proceeds to step S40.

In step S40, the control unit 103 determines whether or not an instruction to set the relative time is made by the user. Arranged on a screen of the relative clock time display application is a button to display the aforementioned relative time setting clock used to set the relative time, for example, where the control unit 103 detects the instruction to set the relative time by monitoring the button operated by the user. The process proceeds to step S80 below when the determination in step S40 is negative. On the other hand, the process proceeds to step S50 when the determination in step S40 is affirmative.

In step S50, the control unit 103 displays the relative time setting clock illustrated in FIG. 2 on the touch panel 101 and proceeds to step S60.

In step S60, the control unit 103 determines, on the basis of an output signal from the touch panel 101, whether or not the relative time is set by moving the relative time setting hands 2d to 2f on the relative time setting clock by the user, having completed the operation. The process proceeds to step S80 below when the determination in step S60 is negative. On the other hand, the process proceeds to step S70 when the determination in step S60 is affirmative.

In step S70, the control unit 103 specifies the settings of the relative time performed by the user on the relative time setting clock, and records in the flash memory the relative time setting information which specifies the settings of the relative time. The process thereafter proceeds to step S80.

In step S80, the control unit 103 determines whether or not an instruction to end the relative clock time display application is made by the user. The user can give the instruction to end the relative clock time display application by performing a predetermined end instruction operation set by the relative clock time display application, for example. The process returns to step S20 when the determination in step S80 is negative. On the other hand, the process is ended when the determination in step S80 is affirmative.

The following effects can be obtained according to the present examples described above.

(1) The control unit 103 is adapted to accept the setting of the relative time that is different from the actual time and has a relative relationship therewith, perform timing on the basis of the relative time accepted, and display the sky clock corresponding to the current clock time in the relative time. Accordingly, the user can set the relative time at will to suit his own perception of time. Moreover, the sky clock corresponding to the relative clock time is displayed to be able to make the user aware of the relative time by using an image. The user can further use the relative clock time display device 100 to adjust the biological clock of the user, recover from the jet lag when traveling abroad, adjust the gap between the personal daily rhythm of the user and the actual time, or play with time in order to spend a day happily, as described above.

(2) The control unit 103 is adapted to display the relative time setting clock illustrated in FIG. 2 on the touch panel 101, and accept the setting of the relative time by accepting the correspondence between the actual time and the relative time designated by the user. Accordingly, the user can set the relative time with a simple operation while visually checking the correspondence between the actual time and the relative time.

(3) In displaying the sky clock, the control unit 103 is adapted to display the image indicating the morning glow when the relative clock time corresponds to the morning in the actual time, and display the image indicating the clear sky when the relative clock time corresponds to the daytime in the actual time. Moreover, the control unit 103 is adapted to display the image indicating the sunset when the relative clock time corresponds to the evening in the actual time, and display the image indicating the starry sky when the relative clock time corresponds to the nighttime in the actual time. Accordingly, the user can instinctively grasp the current relative time by looking at the sky clock.

(4) In displaying the sky clock, the control unit 103 is adapted to be able to display the relative clock time in numbers or characters on top of the image of the sky. The user can therefore grasp the current relative clock time.

Variation

Note that the relative clock time display device 100 in the aforementioned example can be modified as follows.

(1) In the aforementioned example, there has been described the example where the control unit 103 notifies the user of the relative clock time by displaying the sky clock on the touch panel 101. The notification of the relative clock time may however be performed by another method. The color or brightness of an image may be changed according to the relative clock time, for example.

The control unit 103 may display the image with a bright color or increase the brightness of the image when the relative clock time corresponds to morning or daytime in the actual time, for example. On the other hand, the control unit 103 may display the image with a dark color or decrease the brightness of the image when the relative clock time corresponds to evening or nighttime in the actual time.

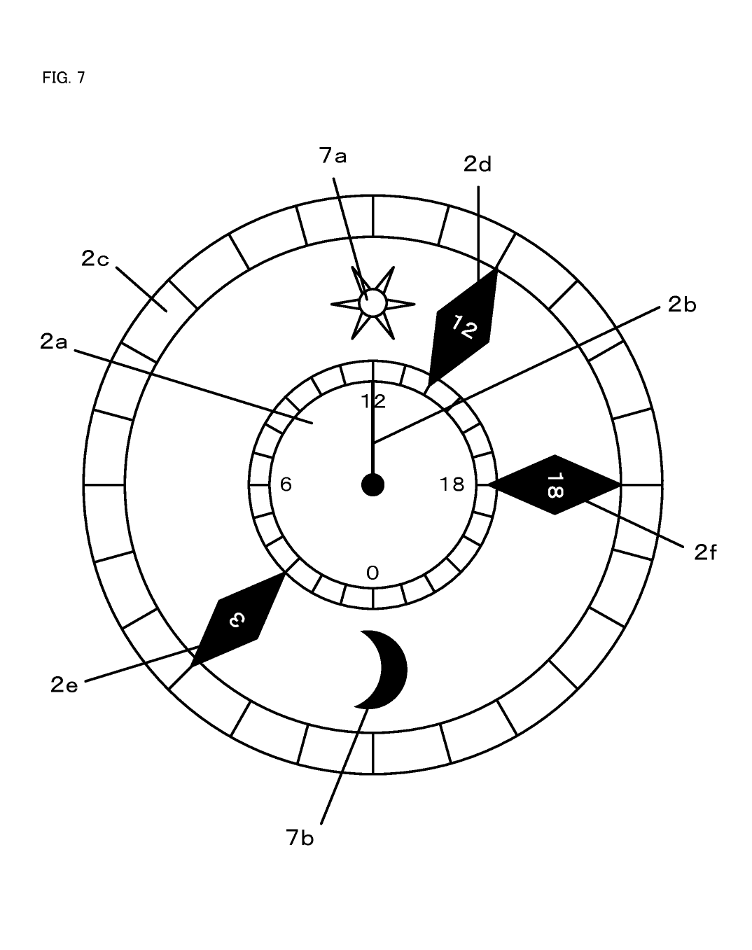

(2) In the aforementioned example, there has been described the example where the user sets at will the relative time that suits his perception of time relative to the 24 hours in the actual time, on the relative time setting clock illustrated in FIG. 2. The relative time setting clock is however not limited to the example illustrated in FIG. 2. As illustrated in FIG. 7, for example, it may be adapted to display a mark of the sun 7a in the background for the hours corresponding to daytime in the actual time, and display a mark of the moon 7b in the background for the hours corresponding to nighttime in the actual time.

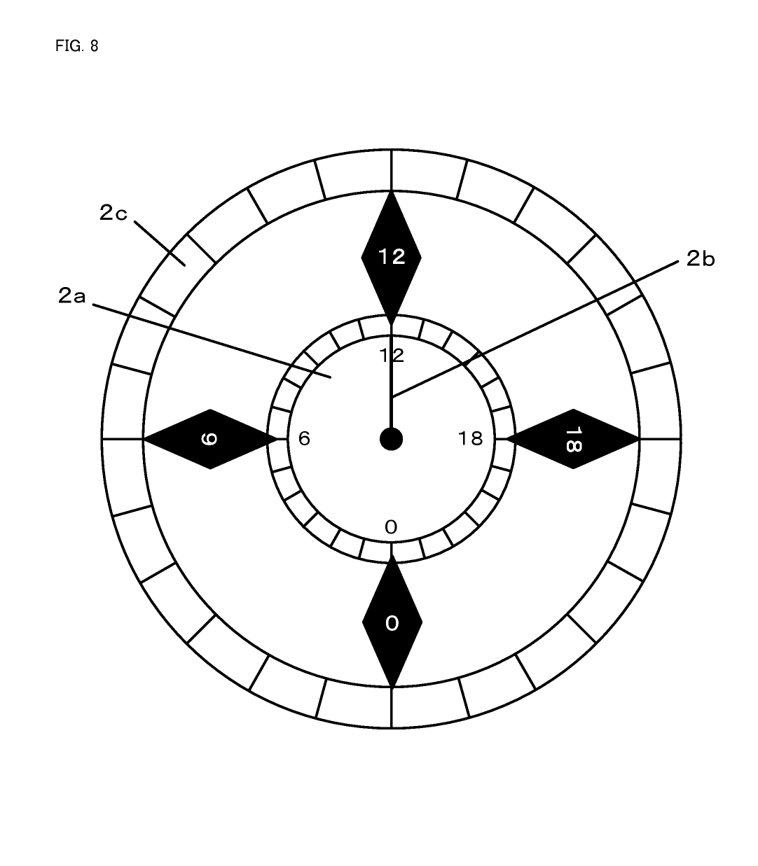

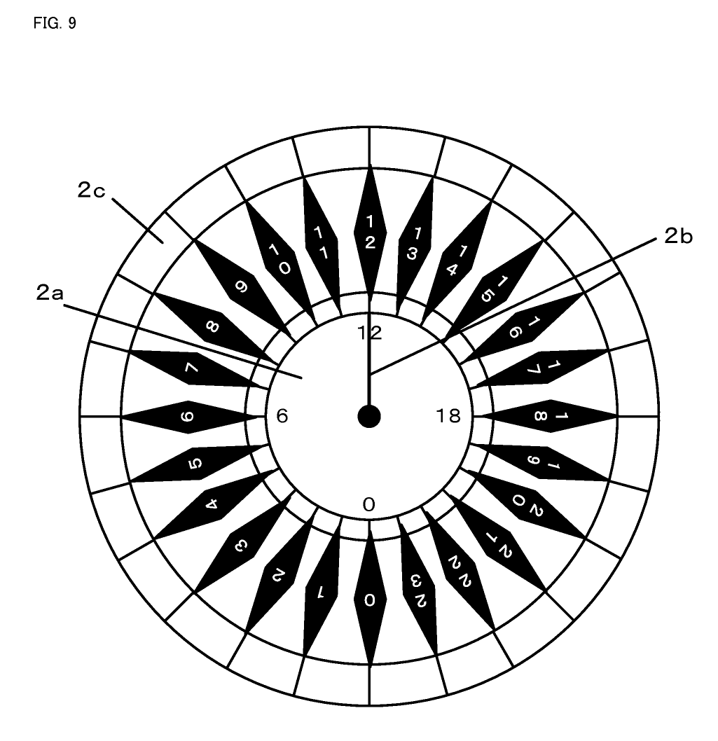

(3) In the aforementioned example, there has been described the example where, in the relative time setting clock, the relative time setting hand 2d is the hand indicating 12 o'clock in the relative time, the relative time setting hand 2e is the hand indicating 3 o'clock in the relative time, and the relative time setting hand 2f is the hand indicating 18 o'clock in the relative time. The relative time setting hand is however not limited to the example illustrated in FIG. 2. For example, there may be arranged four relative time setting hands at an interval of six hours as illustrated in FIG. 8, or there may be arranged 24 relative time setting hands at an interval of one hour as illustrated in FIG. 9. There may also be arranged a plurality of relative time setting hands at another time interval. Note that the larger the number of relative time setting hands, the finer the relative time can be set.

(4) In the aforementioned example, there has been described the example where the control unit 103 notifies the user of the relative clock time by displaying the image of the sky indicating the relative clock time on the touch panel 101. However, the control unit 103 may be adapted to notify the user of the relative clock time by displaying a video of the sky indicating the relative clock time on the touch panel 101.

(5) In the aforementioned example, there has been described the example where, in displaying the sky clock, the control unit 103 is adapted to display the image indicating the morning glow when the relative clock time corresponds to the morning in the actual time, and display the image indicating the clear sky when the relative clock time corresponds to the daytime in the actual time. Moreover, there has been described the example where the control unit 103 displays the image indicating the sunset when the relative clock time corresponds to the evening in the actual time, and displays the image indicating the starry sky when the relative clock time corresponds to the nighttime in the actual time. The method of displaying the sky clock is however not limited to such examples. In displaying the sky clock, for example, the control unit 103 may be adapted to display: an image representing the morning sun when the relative clock time corresponds to the morning in the actual time; an image representing the sun high up in the sky when the relative clock time corresponds to the daytime in the actual time; an image representing the setting sun when the relative clock time corresponds to the evening in the actual time; and an image representing the moon when the relative clock time corresponds to the nighttime in the actual time. When displaying the moon, it may be adapted to express the waxing and waning of the moon on the basis of the age of the moon that day. Moreover, it may be adapted to change the color of the image of the sky to match the color of the sky at that clock time.

In displaying the sky clock, the control unit 103 may also be adapted to display at random an image of a migratory bird, a shooting star, a UFO, or a swallow within the image of the sky. Furthermore, the control unit 103 may be adapted to specify the current location of the relative clock time display device 100, specify a sunrise time and a sunset time of that region, and change the image displayed as the sky clock or the color of the image of sky in accordance with the sunrise time and the sunset time. Note that the current location of the relative clock time display device 100 may be specified by user setting or measurement using a GPS. It may further be adapted to acquire weather forecast information of that region and use an image of sky in accordance with a current weather.

It may also be adapted to mount a bearing sensor to the relative clock time display device 100 to display an image in accordance with the sky in the direction in which the relative clock time display device 100 is facing. In displaying the image of the starry sky, for example, the user can enjoy watching a virtual constellation when it is adapted to display an image including a star that is visible in the direction in which the relative clock time display device is facing.

(6) In the aforementioned example, there has been described the example where, in displaying the sky clock, the control unit 103 can display the relative clock time in numbers or characters on top of the image of the sky. It may however be adapted such that, in displaying the sky clock, the user can select at will whether to display or not display the relative clock time on top of the image of the sky so that the display of the relative clock time can be switched between display and hide by the control unit 103 on the basis of the selection made by the user. It may also be adapted to be able to display the actual clock time along with the relative clock time.

(7) In the aforementioned example, there has been described the example where the sky clock is output and displayed on the touch panel 101. However, it may be adapted to mount, to the relative clock time display device 100, an interface used to be connected to an external display unit such as a television or a monitor, and output and display the sky clock on the external display unit connected through the interface. When the sky clock is displayed on the external display unit, the relative clock time display device may be adapted to be connected to a plurality of display units at the same time so that the sky clock at each angle is displayed on each monitor arranged 360 degrees to get a panorama display.

(8) The relative clock time display device 100 in the aforementioned example may be adapted to be further equipped with an energy-saving function such as a sleep function which shifts the relative clock time display device 100 to a sleep state or a brightness adjustment function which adjusts the brightness of the touch panel 101.

(9) The relative clock time display device 100 in the aforementioned example can also be used in phototherapy known to have an effect of adjusting a biological rhythm.

(10) Assumed to be provided as a smartphone including a call function, the relative clock time display device 100 in the aforementioned example includes the microphone 105 and the speaker 106, but the microphone 105 and the speaker 106 are not included when an information terminal not including the call function is used as the relative clock time display device 100. The communication module 102 is not needed either when using a terminal which need not include a communication function. Furthermore, the memory slot 104 is not needed when the flash memory included in the control unit 103 is used as an internal memory and there is no need to use an external memory.

(11) In the aforementioned example, there has been described the example where the relative clock time display program is provided as the relative clock time display application executable on the smartphone, the relative clock time display application being installed to the relative clock time display device 100 by recording in the non-volatile memory the program data of the relative clock time display application obtained via download or the like. Accordingly, the relative clock time display program may be supplied as a computer program product that can be read by a computer by using carriers used in the Internet, a communication line of personal computer communication, or a leased communication line. The program may also be supplied as a computer-readable computer program product that is provided while recorded in a recording medium such as a CD-ROM or a DVD-ROM.

Note that the present invention is not to be limited to the configuration described in the aforementioned example as long as the characteristic function of the present invention is retained. Moreover, the aforementioned example may be combined with a plurality of variations.

1. A relative clock time display device comprising:
a control unit that accepts setting of time that is referred to as a relative time, which is different from an actual time and in a relative relationship with the actual time, performs timing on a basis of the relative time accepted by the control unit, specifies a current clock time, which is referred to as a relative clock time, in the relative time on a basis of the timing performed by the control unit, and displays, on a display unit, an image or video according to the relative clock time specified by the control unit.

2. The relative clock time display device according to claim 1, wherein the control unit displays on the display unit a clock image representing a clock, and
wherein the control unit accepts setting of the relative time by accepting designation of correspondence between the actual time and the relative time on the clock image that is displayed by the control unit.

3. The relative clock time display device according to claim 1, wherein the control unit changes at least one of color and brightness of the image displayed on the display unit according to the relative clock time.

4. The relative clock time display device according to claim 3, wherein the control unit displays an image or video of sky on the display unit and changes at least one of color and brightness of the sky according to the relative clock time.

5. The relative clock time display device according to claim 1, wherein the control unit displays the relative clock time on top of the image or the video.

6. A non-transitory computer readable medium embodying a relative clock time display program which causes a computer to execute:
a relative time setting acceptance step of accepting, at a control unit, setting of time that is referred to as a relative time, which is different from an actual time and in a relative relationship with the actual time;
a relative time timing step of performing, by the control unit, timing on a basis of the relative time accepted in the relative time setting acceptance step;
a relative clock time specifying step of specifying, by the control unit, a current clock time, which is referred to as a relative clock time, in the relative time on a basis of the timing performed in the relative time timing step; and
a display control step of displaying, by the control unit on a display unit, an image or video according to the relative clock time specified in the relative clock time specifying step.

7. The non-transitory computer readable medium embodying the relative clock time display program according to claim 6, further comprising a clock image display step of displaying by the control unit on the display unit a clock image representing a clock,
wherein, in the relative time setting acceptance step, setting of the relative time is accepted by accepting designation of correspondence between the actual time and the relative time on the clock image that is displayed in the clock image display step.

8. The non-transitory computer readable medium embodying the relative clock time display program according to claim 6, wherein, in the display control step, at least one of color and brightness of the image displayed on the display unit is changed by the control unit according to the relative clock time.

9. The non-transitory computer readable medium embodying the relative clock time display program according to claim 8, wherein, in the display control step, an image or video of sky is displayed on the display unit, and at least one of color and brightness of the sky is changed by the control unit according to the relative clock time.

10. The non-transitory computer readable medium embodying the relative clock time display program according to claim 6, wherein, in the display control step, the relative clock time is displayed by the control unit on top of the image or the video.
